(19) United States
(12) Patent Application Publication
(10) Pub. No.: US 2008/0183112 A1
(43) Pub. Date: Jul. 31, 2008

(54) LEG MASSAGE MACHINE

(76) Inventor: MASAYA TAKEBE, Kobe-shi (JP)

Correspondence Address: ECKERT SEAMANS CHERIN & MELLOTT, 600 GRANT STREET, 44TH FLOOR, PITTSBURGH, PA, 15219, US

(21) Appl. No.: 12/021,447

(22) Filed: Jan. 29, 2008

(30) Foreign Application Priority Data
Jan. 31, 2007 (JP) 2007-020494

(51) Int. Cl. A61H 1/00; A61H 7/00; A61H 19/00

(52) U.S. Cl. 601/29; 601/104; 601/134

(57) ABSTRACT

This invention provides a leg massage machine comprising an acupressure member which is adapted to move past a desired portion in the sole of the user to produce an enhanced massage effect and which is unlikely to cause the user to feel a pain or discomfort. The leg massage machine comprises a recessed portion 70 for the user to insert his or her foot thereinto, an acupressure member 85 disposed on a bottom wall of the recessed portion for applying pressure to the sole of the user, a drive mechanism 89 for reciprocatingly moving the acupressure member along the bottom wall of the recessed portion longitudinally thereof, an air bag 80 disposed on each of opposite side walls of the recessed portion, and control means 90 for inflating and contracting the air bags on opposite side walls and controlling the drive mechanism. The control means controls the inflation of the air bags on the side walls and the movement of the acupressure member by the drive mechanism cooperatively.

### FIELD OF THE INVENTION

The present invention relates to leg massage machines for massaging the soles of the person to be treated, and more particularly to a leg massage machine capable of giving an enhanced massage effect to soles.

### BACKGROUND OF THE INVENTION

Leg massage machines are known which comprise an acupressure member reciprocatingly movable longitudinally of the sole of the person to be treated for giving an acupressure massage to the sole (see, for example, JP2005-58300A).

The leg massage machine disclosed in the above patent publication has an acupressure member provided on a bottom wall of a recessed portion for placing the foot of the user thereinto and made movable outwardly and inwardly of the bottom wall by air bags. The acupressure member is also movable longitudinally of the bottom wall. An air bag (hereinafter referred to as a “side air bag”) is provided on each side wall of the recessed portion.

With the leg massage machine described, acupressure member is moved reciprocatingly, with the side bags on opposite sides adjusted in the degree of inflation, whereby the sole is massaged linearly at one of the positions of the inner side, central portion and outer side thereof.

Accordingly, when the inside portion of the sole is massaged from the heel side, a very high massage effect is available in the case where the acupressure member moves past the arch portion, whereas if the acupressure member comes into contact with the bone area at the base of the great toe while moving past the toe base portion, the user will feel a pain or discomfort. Similarly when the acupressure member moves past the center or outer side of the sole, the acupressure member is likely to come into contact with the bone area at the base of one of the toes, causing a pain or discomfort to the user.

### SUMMARY OF THE INVENTION

An object of the present invention is provide a leg massage machine comprising an acupressure member which is adapted to move past a desired portion in the sole of the user to produce an enhanced massage effect and which is unlikely to cause the user to feel a pain or discomfort.

To fulfill the above object, the present invention provides a leg massage machine which comprises:
a recessed portion for the user to insert his or her foot thereinto,
an acupressure member dispose on a bottom wall of the recessed portion for applying pressure to the sole of the user,
a drive mechanism for reciprocatingly moving the acupressure member along the bottom wall of the recessed portion longitudinally thereof,
an air bag disposed on each of opposite side walls of the recessed portion, and
control means for inflating and contracting the air bag on each of the side walls and controlling the drive mechanism,
the control means being operable to control the inflation of the air bag on each of the side walls and the movement of the acupressure member by the drive mechanism cooperatively.

With the leg massage machine of the present invention, the acupressure member is moved while the air bags arrange on respective opposite side walls of the recessed portion are being controlled in the degree of inflation. The sole can be moved laterally leftward or rightward inside the recessed portion by varying the degree of inflation of the side air bags. When moved in this state, the acupressure member can be caused to given an acupressure massage to the sole while moving along a desired curve instead of moving along a straight line.

Accordingly, the acupressure member is capable of giving an acupressure massage along a such a path of movement as to move past a desired part of the user (e.g., the arch, hereinafter referred to merely as a “specified part,” or a “position of high massage effect”) while bypassing a part not desired by the user (e.g., the bone at the base of the toe, hereinafter referred to merely as a “specified part,” or a “specified uncomfortable part”), thus massaging the user with a high acupressure effect without causing any pain or discomfort to the user. Since one of various paths of movement is selectable as stated above, the present machine provides massage in a manner other than a monotonous mode.

The control means may vary the speed of movement of the acupressure member in accordance with the rate of inflation of the air bags on opposite sides, whereby the sole can be massaged at greatly varying speeds without monotony with a remarkably improved effect.

The recessed portion is provided with foot size sensor means for detecting the size of the user's foot as inserted in the recessed portion. The foot size sensor means is electrically connected to the control means, which may be adapted to vary the rate of inflation of the opposite-side air bags and/or the speed of movement of the acupressure member in accordance with the foot size detected by the sensor means. Since the path of movement of the acupressure member is selectable with consideration given to the difference in the position of the arch or in the position of the bone at the base of the toe due to the particular size of the user's foot, a highly effective massage is available irrespective of the foot size.

The control means so controls as to vary the degree of inflation of the opposite-side air bags, whereby the sole of the user is moved inside the recessed portion to shift the position of the acupressure member relative to the sole.

The control means has memory means for storing the specified position of high massage effect in the sole and/or the specified uncomfortable part in the sole. When the acupressure member is moved along the bottom wall of the recessed portion longitudinally thereof by operating the drive mechanism, the degree of inflation of the opposite-side air bags can be so controlled as to cause the acupressure member to move past the specified position of high massage effect in the sole but not to move past the specified uncomfortable part of the sole, whereby massage can be provided with a high effect without causing the user to feel any pain or discomfort.

The specified position may be stored in memory means to cause the acupressure member to move past or detour this position according to a predetermined program. The machine may have a manipulator electrically connected to the control means and to be manipulated by the user, the manipulator having an input unit for inputting the specified position. The control causes the acupressure member to move past or detour the specified position input by the input unit and stored in the memory.

### BRIEF DESCRIPTION OF THE DRAWINGS

FIG. 1 is a perspective view showing a leg massage machine of the invention as it is seen obliquely from the front;

FIG. 2 is a perspective view of the leg massage machine to show a reclining movable assembly as inclined rearward and as seen obliquely from the front;

FIG. 3 is a perspective view showing the leg massage machine as it is seen from the bottom side thereof;

FIG. 4 is a view in section taken along the line X-X in FIG. 1;

FIG. 5 is a perspective view showing a base assembly and the reclining movable assembly as removed therefrom;

FIG. 6 is a perspective view of the reclining movable assembly as it is seen from below;

FIG. 7 is a view in section taken along the line Y-Y in FIG. 1 and showing the reclining movable assembly in a raised upright position;

FIG. 8 is a view in section taken along the line Y-Y in FIG. 1 and showing the reclining movable assembly as inclined rearward;

FIG. 9 is a view in section taken along the line Z-Z in FIG. 1 and showing the reclining movable assembly in the raised upright position, with the leg of the user inserted therein;

FIG. 10 is a view in section taken along the line Z-Z in FIG. 1 and showing the reclining movable assembly as inclined rearward, with the leg of the user inserted therein;

FIG. 11 is a view in section taken along the line Z-Z in FIG. 1 and showing the interior construction of a massage unit in section;

FIG. 12 is a block diagram of control means;

FIG. 13 is a diagram illustrating paths of movement of an acupressure member;

FIG. 14 is a flow chart showing a procedure for changing the path of movement of the acupressure member;

FIG. 15 is a flow chart showing a procedure for giving a definite path of movement to the acupressure member irrespective of the foot size;

FIG. 16 is a diagram illustrating a path of movement of the acupressure member for the member to move past or detour a specified part;

FIG. 17 is a control flow chart for causing the acupressure member to move past or detour the specified part; and

FIG. 18 is a control flow chart for setting the specified part.

### DESCRIPTION OF THE PREFERRED EMBODIMENT

The present invention is applicable to a leg massage machines 10, which will be described below with reference to the drawings.

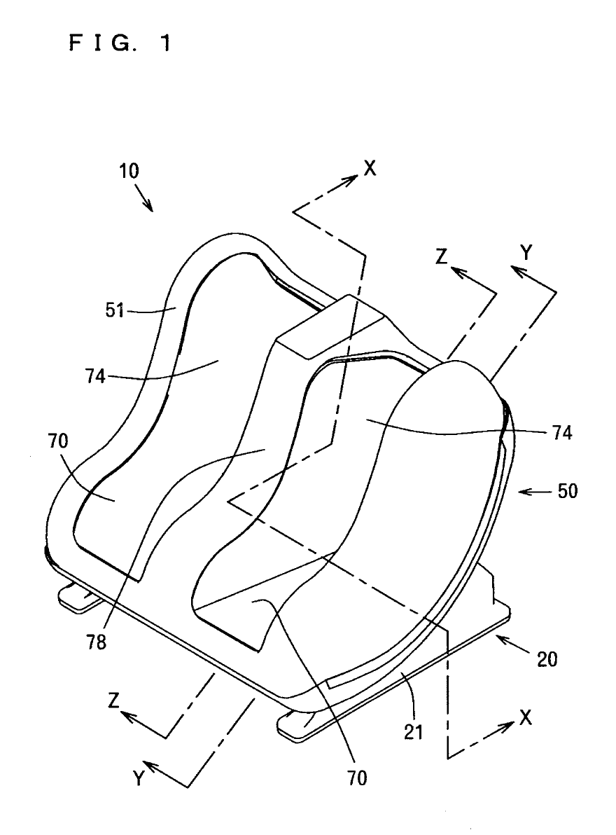

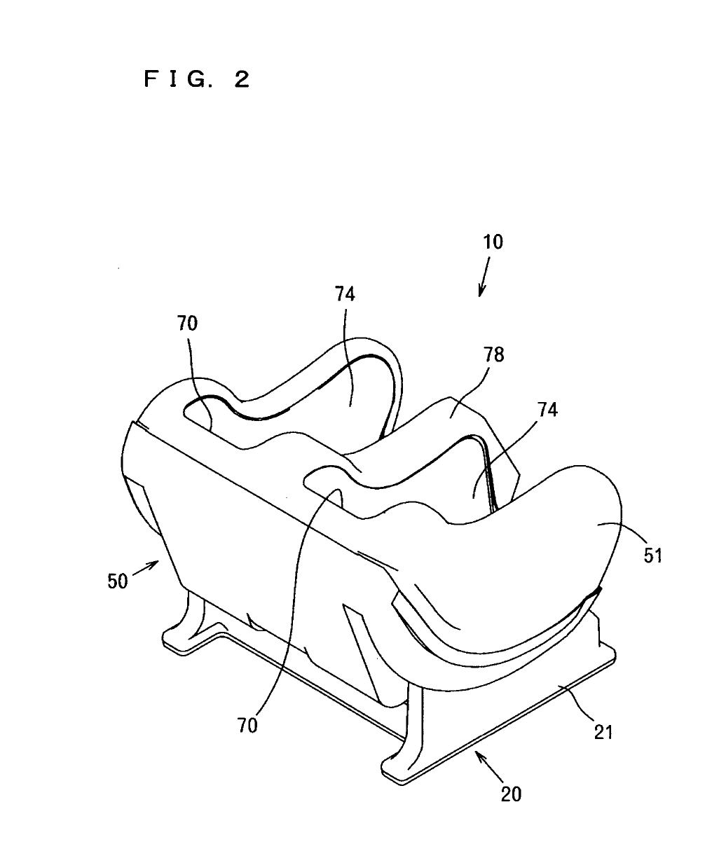

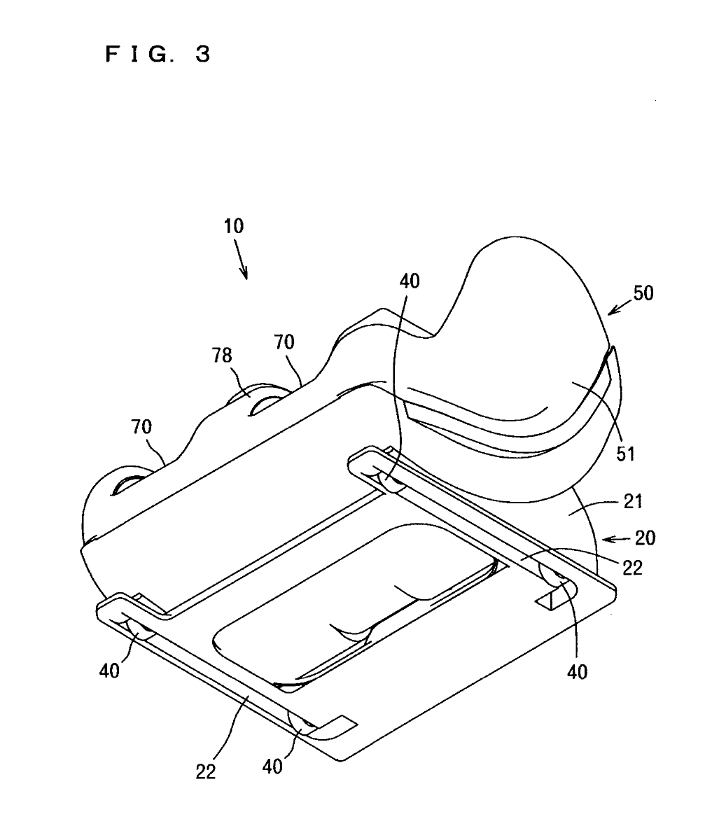

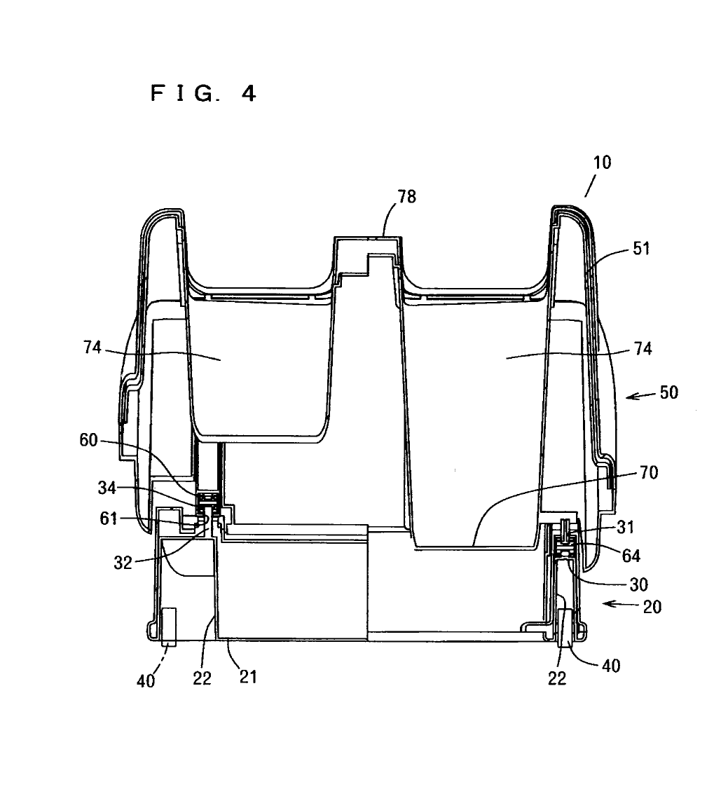

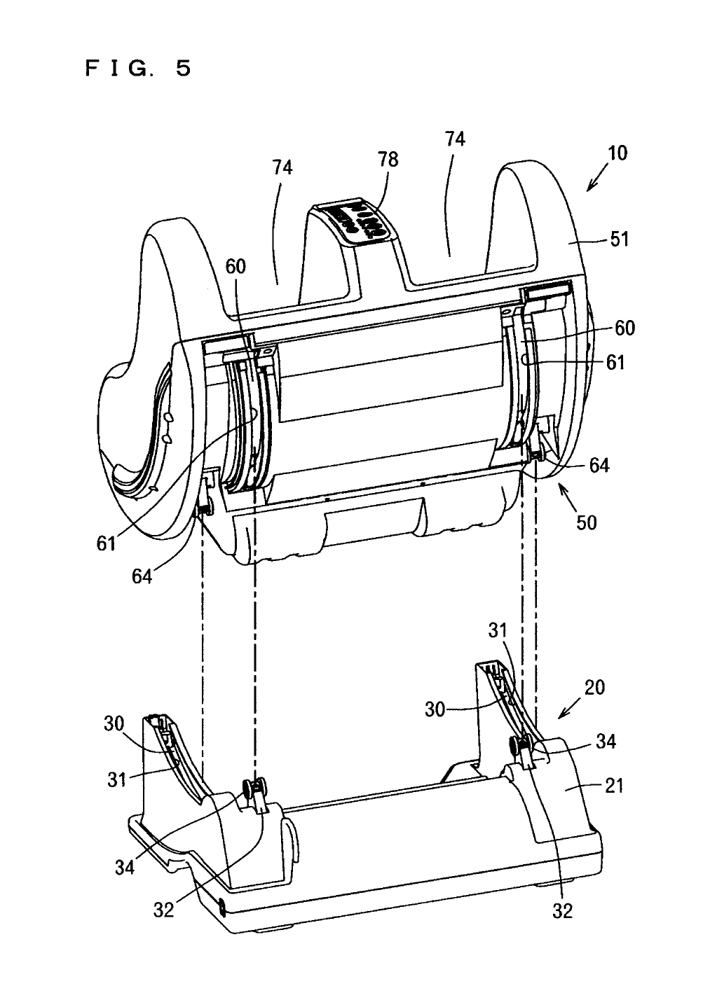

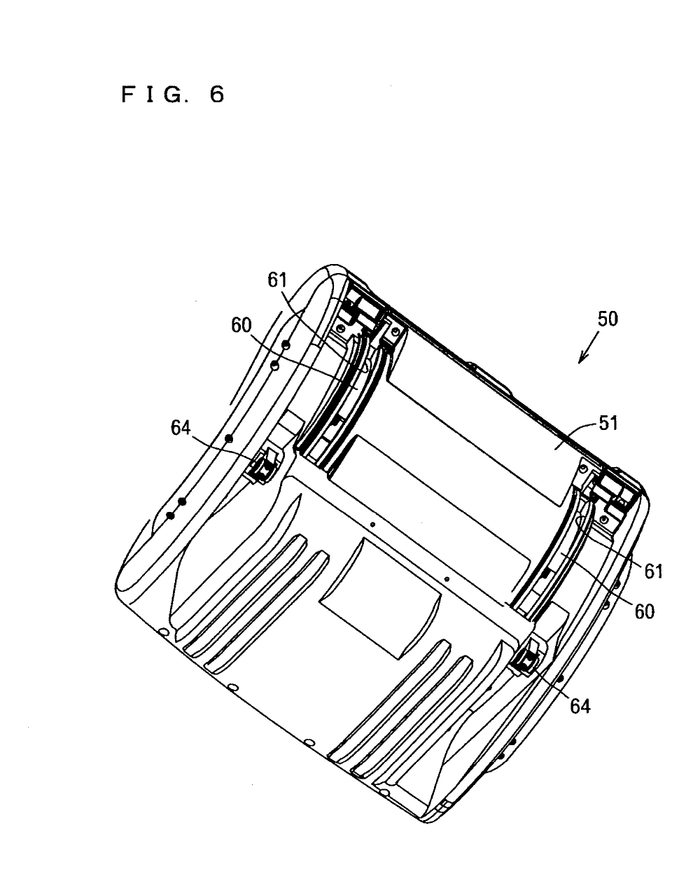

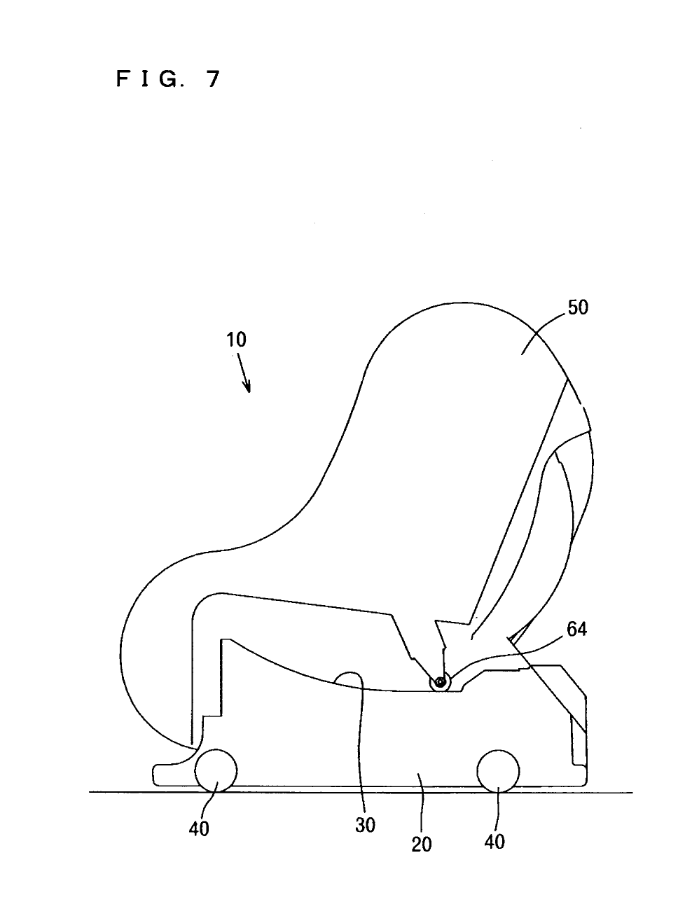

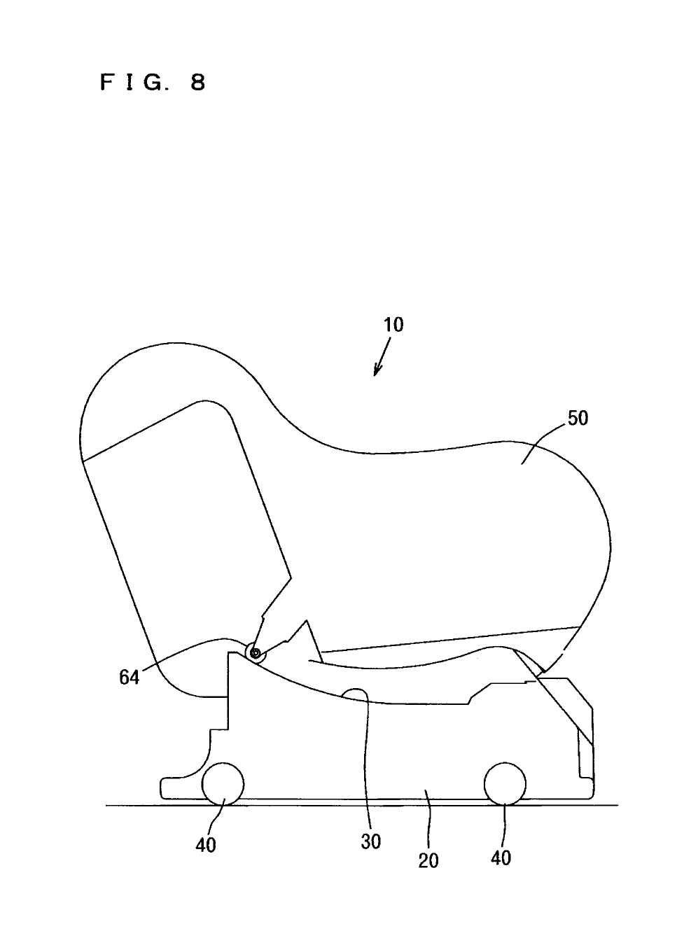

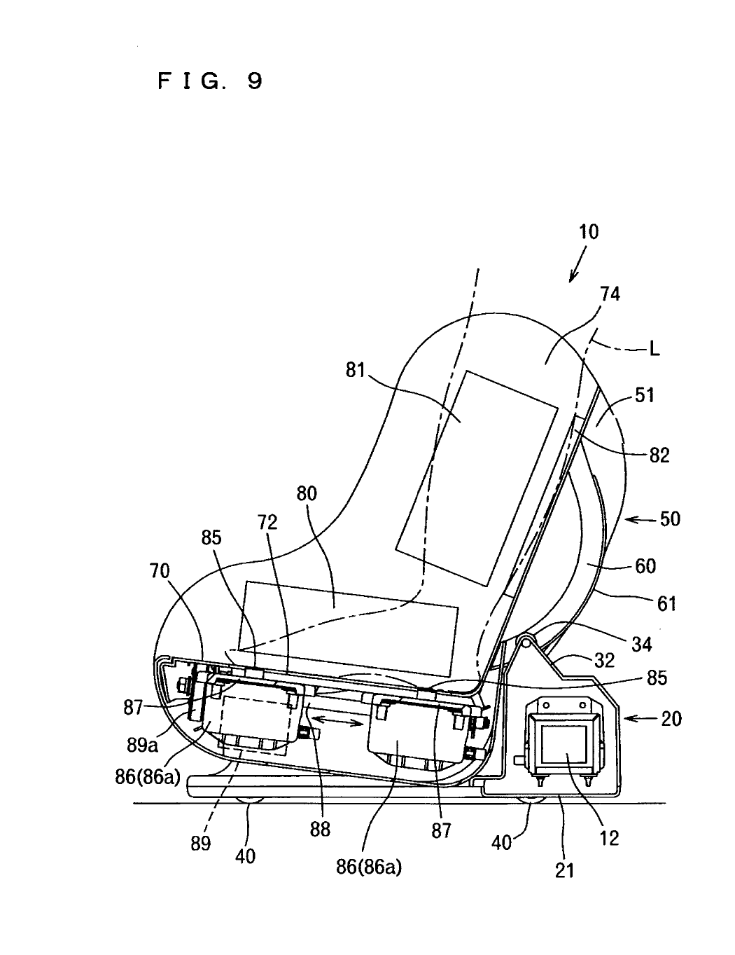

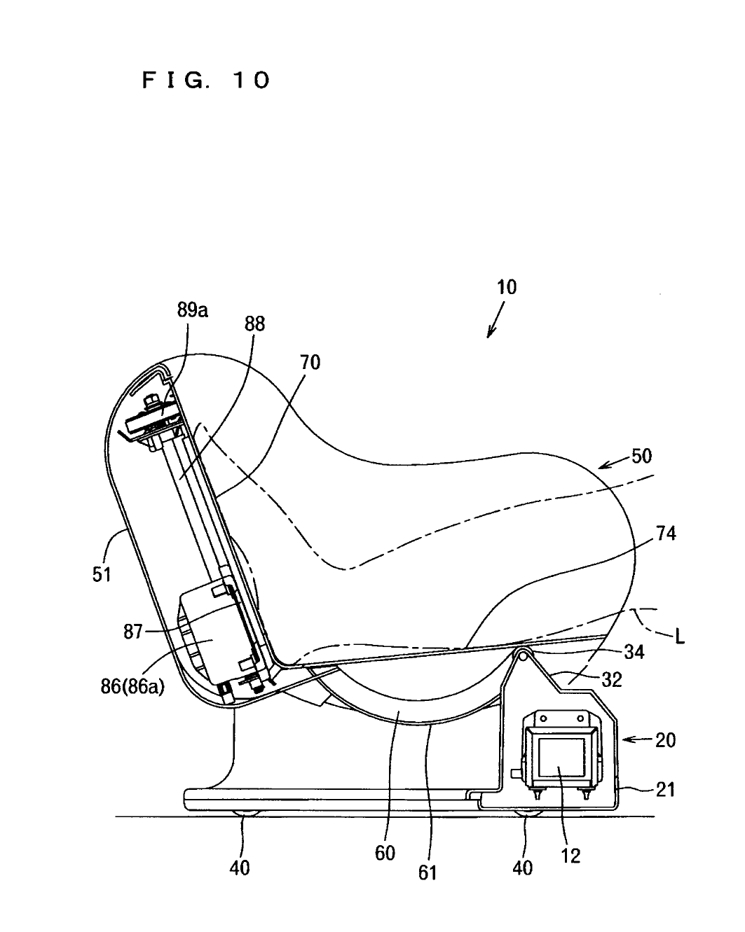

FIG. 1 is a perspective view showing the leg massage machine 10 of the invention as it is seen obliquely from the front, FIG. 2 is a perspective view of the machine to show a reclining movable assembly 50 as inclined rearward and as seen obliquely from the front, FIG. 3 is a perspective view of the machine as it is seen from the bottom side thereof, FIG. 4 is a view in section taken along the line X-X in FIG. 1, FIG. 5 is a perspective view showing a base assembly 20 and the reclining movable assembly 50 as removed therefrom, FIG. 6 is a perspective view of the reclining movable assembly 50 as it is seen from below, FIG. 7 is a view in section taken along the line Y-Y in FIG. 1 and showing the reclining movable assembly 50 in a raised upright position, FIG. 8 is a view in section of the reclining movable assembly 50 as inclined rearward, FIG. 9 is a view in section taken along the line Z-Z in FIG. 1 and showing the reclining movable assembly 50 in the raised upright position, and FIG. 10 is a sectional view of the reclining movable assembly 50 as inclined rearward. FIGS. 7 to 10 are intended to plainly show the shapes of rails 30, 60, with their interior structures omitted or shown schematically.

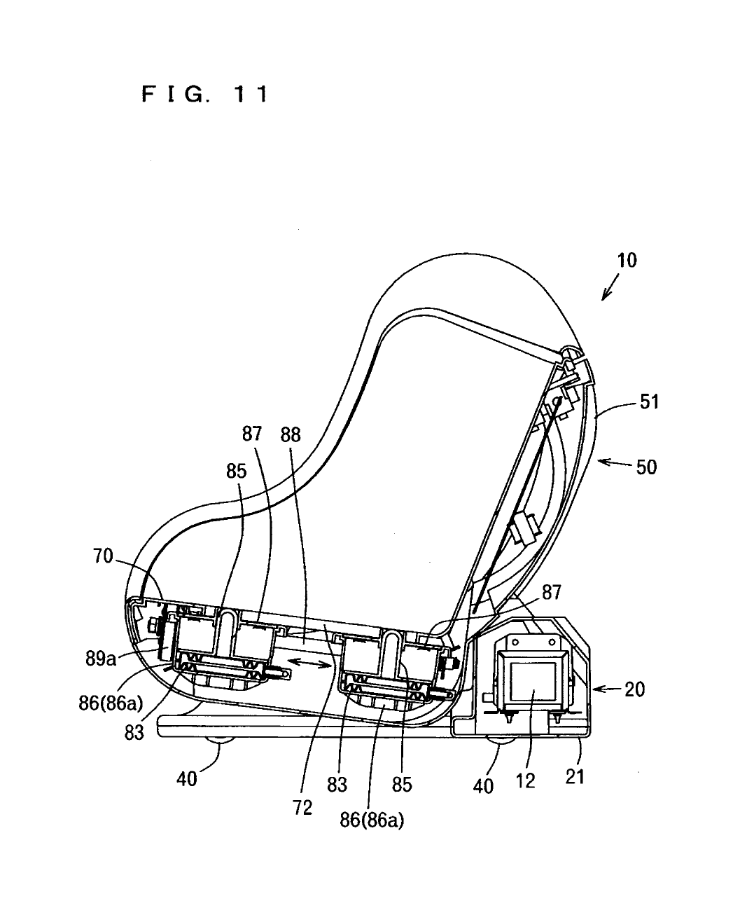

As shown in these drawings, the leg massage machine 10 comprises a base assembly 20 to be placed on the floor, and a reclining movable assembly 50 supported by the base assembly 20 so as to move mockingly. As will be described later, the reclining movable assembly 50 has first recessed portions 70 for the user to insert his or her respective feet or calves thereinto, and second recessed portions 74 for placing the respective feet or calves thereinto. The first recessed portions 70 and the second recessed portions 74 are each provided with air bags or like massage means on the side walls and/or bottom wall thereof. As will be described later, examples of massage means are air bags 80, 81, 82, 83 and acupressure members 85 (see FIGS. 9 and 11).

The base assembly 20 comprises a hollow resin casing 21. Housed in the interior of the base assembly 20 are an air pump 12 for supplying compressed air to the air bags 80, 81, 82, 83 arranged as massage means on the movable assembly 50, a control base panel and a power source unit (not shown).

The base assembly 20 is provided with a pair of opposite rails (hereinafter referred to as “first rails 30, 30”) positioned at its right and left top portions, respectively, as shown in FIGS. 4 and 5 and extending forward or rearward. Each of the first rails 30, 30 is curved downward, has a rectangular cross section and is provided with a narrow slot 31, which is formed in the center of the top wall of the rail and extends longitudinally thereof. Rollers (hereinafter referred to as “second rollers 64, 64”) on the reclining movable assembly to be described below are rollably fitted to the respective first rails 30, 30.

Each of the first rails 30, 30 needs only to be shaped as curved. For example as shown in FIGS. 7 and 8, the rail 30 can be so shaped as to have a circular-arc forward portion and to become linear as the rail extends rearward. With the rails 30, 30 so shaped, the reclining movable assembly 50, while moving mockingly, is inclined with the center of rocking movement slidingly moving forward, instead of rockingly moving about a fixed support point (phantom support point), enabling the legs of the user to move under no burden.

Incidentally, the first rails 30 may have a circular-arc shape.

As shown in FIGS. 5 and 9, the base assembly 20 is provided at its rear end with a pair of right and left upward brackets 32, 32. Rollers (hereinafter referred to as “first rollers 34, 34”) fitting to respective rails (hereinafter referred to as “second rails 60, 60”) on the reclining movable assembly 50 to be described later are rollably supported at the upper ends of the brackets 32, 32. The first rollers 34, 34 can be made from a rubber or resin material.

As shown in FIGS. 3 and 4, two furrows 22, 22 are formed in the lower wall of the base assembly 20, and wheels 40, 40 are provided in the furrows 22, 22, rendering the leg massage machine 10 movable forward and rearward along the floor.

The reclining movable assembly 50 comprises a hollow resin casing 51. The casing 51 has a lower portion projecting forward and projects upward at its rear end. The casing 51 has a pair of right and left first recessed portions 70, 70 for the user to insert his or her respective feet or calves thereinto, and second recessed portions 74, 74 extending from the rear ends of the respective first recessed portions 70, 70 for the user to place his or her respective feet or calves thereinto as shown, for example, in FIGS. 1 and 4. A center wall 78 is provided between the first recessed portions 70, 70 and between the second recessed portions 74, 74. As will be described later, the first recessed portions 70, 70 and the second recessed portions 74, 74 are provided with massage means for massaging the user.

As shown in FIGS. 5, 6 and 9, the first rollers 34, 34 on the base assembly 20 are fittable to the second rails 60, 60 which are provided at opposite sides of the rear end of the reclining movable assembly 50. Each of the second rails 60 is curved to bulge rearward, rectangular in cross section and provided with a narrow slot 61, which is formed in the rear wall of the rail 60 and extends longitudinally thereof.

The second rails 60, 60 need only to be curved in shape, and are in a circular-arc shape according to the illustrated embodiment. When to be in the circular-arc shape, the rails are preferably about 90 to 120 degrees in the angle of circular arc. The second rails 60 may have the same curved form as the first rails 30 on the base assembly 20, or may be made different therefrom in curvature, length or angle of circular arc.

The second rollers 64, 64 fittable to the respective first rails 30, 30 on the base assembly 20 are rollably supported by opposite sides of midportion, with respect to the front-rear direction, of the reclining movable assembly 50. The second rollers 64, 64 can be made from a rubber or resin material.

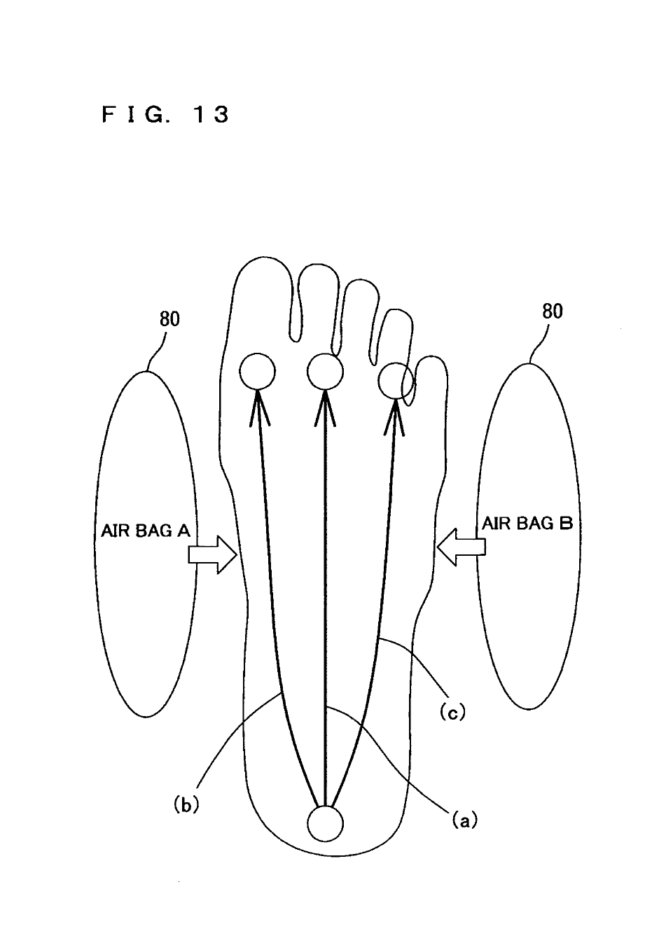

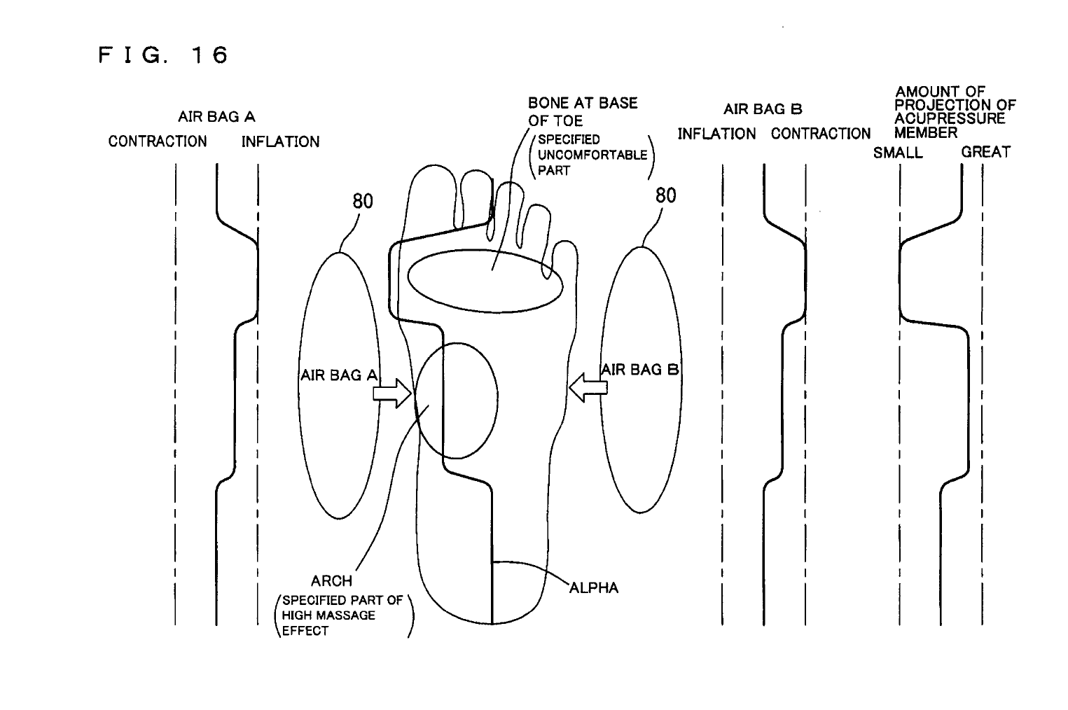

The first recessed portions 70, 70 and the second recessed portions 74, 74 are provided with massage means on their side walls and bottom walls. According to the present embodiment, the massage means are acupressure members 85, 85 provided on the bottom walls of the first recessed portions 70, 70, left and right air bags 80, 80 provided on opposite sidewalls of the first recessed portions 70, 70, left and right air bags 81, 81 provided on opposite side walls of the second recessed portions 74, 74 and air bags 82 provided on the respective bottom walls of the portions 74, 74 as seen in FIG. 9. The left and right air bags 80, 80 provided on opposite side walls of each first recessed portion 70 are so arranged as to hold therebetween the foot of the user as inserted in the recessed portion 70 as shown in FIGS. 13 and 16 (air bags A and B).

With reference to FIGS. 9 and 11, each acupressure member 85 is projectable from and retractable into a slit 72 formed in the bottom wall of the first recessed portion 70 and elongated in the front-rear direction, and is movable forward and rearward along the slit 72. Stated more specifically with reference to FIG. 11, the acupressure member 85 is connected at its lower end to an air bag 83 housed in a case 86. The acupressure members 85, 85 in the right and left first recessed portions 70, 70 are accommodated in the corresponding right and left cases 86, providing massage units 86a. The left and right massage units 86a are connected by a connector plate 87 and are connected to a drive mechanism so as to be reciprocatingly movable forward and rearward along the first recessed portions 70.

The drive mechanism consists mainly of a motor 89. The connector plate 87 is provided with a screw tube (not shown), which is connected to a screw rod 88 supported on the bottom wall of the first recessed portion 70 in parallel thereto. The screw rod 88 is coupled to the motor 89 (see FIG. 9) via a reduction gear mechanism 89a. When rotated, the screw rod 88 moves the connector plate 87 forward and rearward, moving the acupressure member 85 along the slit 72. The acupressure member 85 is shown as moved to the forward position and rearward position in FIGS. 9 and 11.

Pipes are connected to the air bags 80, 81, 82 provided in the opposite first recessed portions 70, 70 and second recessed portions 74, 74 and to the air bags 83 for projecting or retracting the acupressure members 85. The pipes extend into the casing 51 of the reclining movable assembly 50. An electromagnetic valve (not shown) is connected to each of the pipes. The pipes extending from the electromagnetic valves extend into the base assembly 20 and are connected to the air pump 12. Preferably the pipes upstream from the valves are combined into a single pipe or several pipes for connection to the air pump 12. This reduces the number of pipes interconnecting the reclining movable assembly 50 and the base assembly 20.

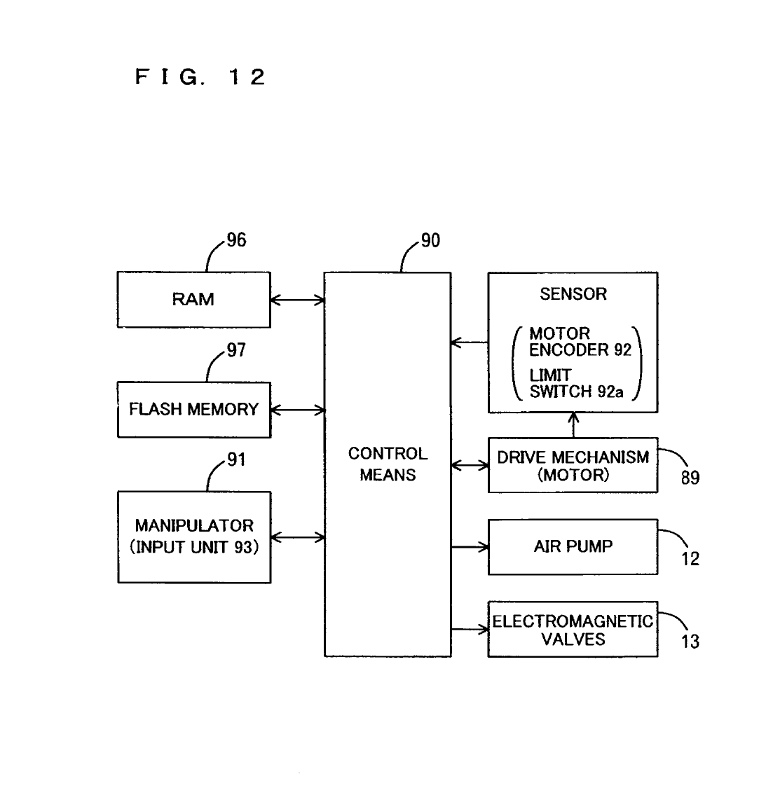

The leg massage machine 10 of the invention is entirely controlled by control means 90. Connected to the control means 90 are, as shown in FIG. 12, the air pump 12 and electromagnetic valves 13 for inflating the massage means, i.e., air bags 80, 81, 82, 83 according to the present embodiment, the motor 89 for adjusting the position of the massage units 86a each having the acupressure member 85 and air bag 83, a manipulator 91, a RAM 96 having stored therein various programs and massage courses (to be described later), a flash memory 97, etc.

The manipulator 91 has in addition to various manual switches an input unit 93 (to be described later) for manually inputting a specified position of high massage effect and specific uncomfortable position.

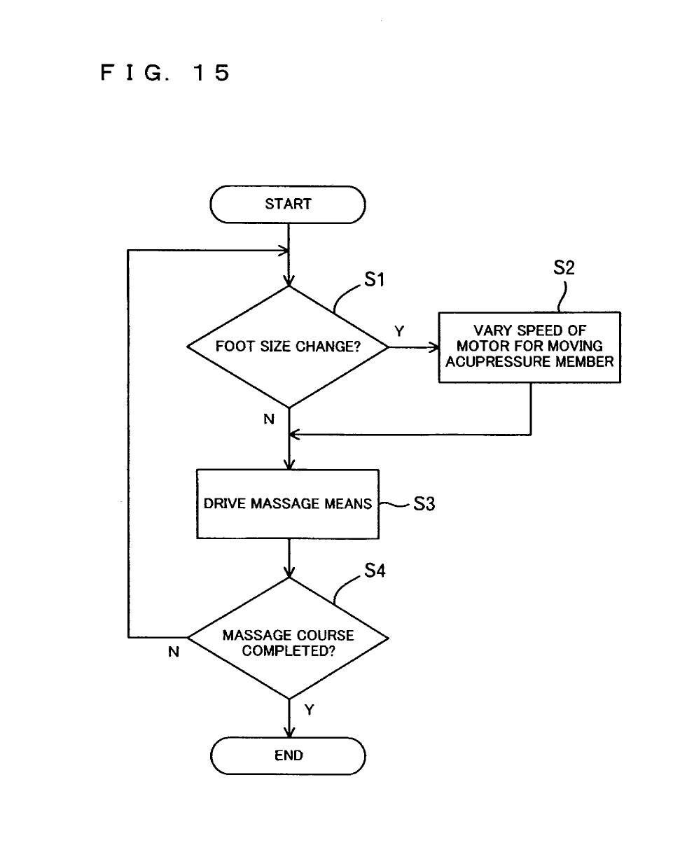

When giving an acupressure massage by the acupressure members 85, the leg massage machine 10 provided by the invention is adapted to alter the path of movement of the acupressure member 85 relative to the sole as desired, by varying the degree of inflation of the air bags 80, 80 (air bags A and B in FIGS. 13 and 15) arranged in the first recessed portion 70.

For example with reference to the left and right air bags A and B shown in FIG. 13, the acupressure member 85 can be given a path of movement (a) of FIG. 13 for massaging the center of the sole by controlling the illustrated left air bag A and right air bag B so as to inflate or contract these bags at the same time and operating the drive mechanism for the acupressure member 85 in this state. Further if the left air bag A only is inflated while the acupressure member 85 is moving from the heel side, the sole is moved toward the air bag B, so that a path of movement (b) of FIG. 13 can be given to the acupressure member 85 relative to the sole. The acupressure member 85 therefore moves past the arch to massage the sole on the great toe side. Further if the right air bag B only is inflated while the acupressure member 85 is moving from the heel side, the sole is moved toward the air bag A, so that a path of movement (c) of FIG. 13 can be given to the acupressure member 85 relative to the sole for the acupressure member 85 to massage the sole on the fifth toe side.

In combination with the above mode of control, the rotational speed of the motor 89 for reciprocatingly moving the massage unit 86a carrying the acupressure member 85 is varied, whereby the acupressure member can be moved along a desired path for massaging in addition to massaging by a straight movement.

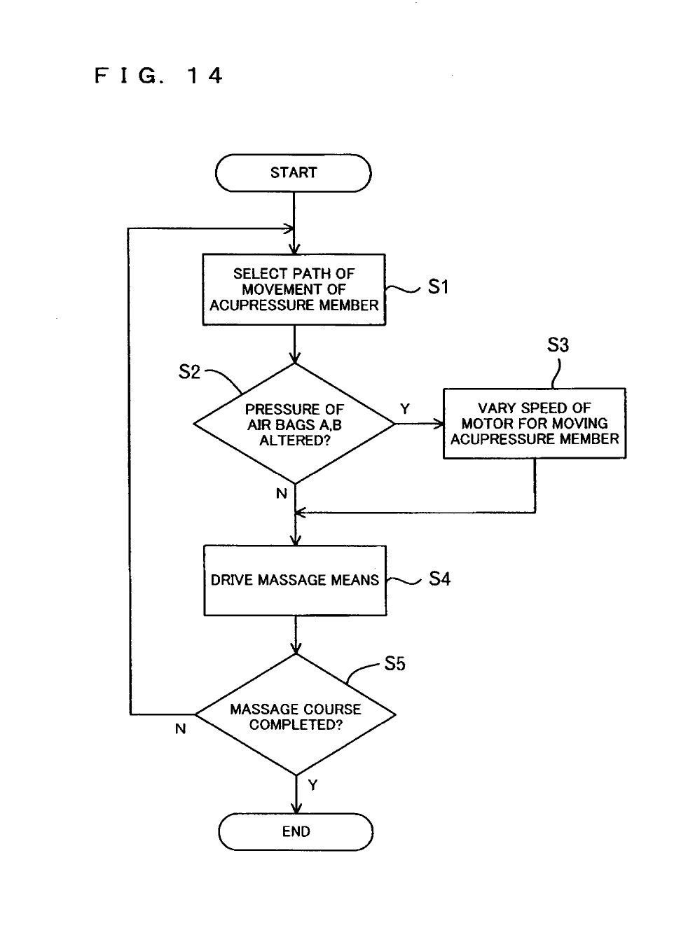

A description will now be given with reference to the flow chart of FIG. 14. One of the paths of movement of the acupressure member 85 is selected in step 1. (For example, the path (a), (b) or (c) of FIG. 13 is selected.) According to the selected course, the pressure of the air bags A and B is thereafter altered (step 2). With the air bags A and B set at the specified rate of inflation or contraction, step 3 follows to vary the rotational speed of the motor 89 for moving the acupressure member 85, and a massage operation is started (step 4). Consequently, the acupressure member 85 can be moved along the desired path at the specified speed.

When a command to stop the massage operation is given by an action of the user or a timer or the like, the massage course is completed (step 5).

Since the foot size differs from user to user, it is likely that the path of movement desired by the user can not be realized even the path of movement of the acupressure member 85 is controlled by the above procedure. In this case, the speed of movement of the acupressure member 85 and the degree of inflation of the air bags 80, 80 are adjusted in accordance with the foot size detected by foot size sensor means on the bottom wall of the first recessed portion 70 for detecting the foot size of the user. This assures a movement along a predetermined path for acupressure massaging.

The foot size of the user detectable by the amount of projection of the acupressure member 85 and foot size sensor means including various sensors. With reference to the flow chart of FIG. 15, a change is detected in the foot size of the user (step 1), whereupon the rotational speed of the motor 89 for moving the acupressure member 85 is made greater when the foot size is great than when the foot size is small (step 2), and a massage operation is started (step 3). This ensures a massage along the same path of movement relative to the sole irrespective of the foot size.

When a command to stop the massage operation is given by an action of the user or a timer or the like, the massage course is completed (step 4).

FIG. 16 shows that the acupressure member 85 is caused to move along a path alpha which is made complex to achieve an enhanced massage effect.

The acupressure member 85 is caused to move past a specified part of increased massage effect, such as the arch wherein massage is concentrically given among other parts of the sole, whereas the member 85 is caused to detour a specified part, such as the bone area of at the base of the great toe, where the user feels discomfort or a pain if the acupressure member 85 comes into contact with the bone area, so as to increase the massage effect on the sole to the greatest possible extent.

The foot size may be manually selected from among a plurality of predetermined sizes.

FIG. 16 shows the relationship between the moved position of the acupressure member 85 and the degree of inflation of the left and right air bags A and B in the case where the acupressure member 85 is caused to move along the path alpha relative to the sole,

While the acupressure member 85 is moving in the heel side, the two air bags A and B are inflated to a medium degree to cause the member 85 to move along the center of the heel side. When the acupressure member 85 moves forward from the heel side, the left air bag A is inflated with the right air bag B contracted to move the member 85 past the arch (specified part of high massage effect) and to thereby move the sole rightward in the drawing relative to the member 85, whereby the sole can be massaged with an increased effect.

When the acupressure member 85 moves further forward and reaches the base of the great toe, the left air bag A is inflated to the greatest degree with the right air bag B contracted to cause the member 25 to make a detour around the bone at the base of the toe (specified uncomfortable part), preventing the member 25 from coming into contact with the bone area. This ensures a comfortable massage without the likelihood that the user will feel a pain or discomfort.

To produce a further increased massage effect in moving the acupressure member 85 along the path alpha relative to the sole, the amount of projection of the member 85 may be altered in accordance with the position of the member 85. FIG. 16 shows the desired amount of projection of the acupressure member 85 relative to the position thereof.

With reference to the drawing, the acupressure member 85 is given an increased amount of projection when moving past the specified part of high massage effect, whereas the member 85 is given a decreased amount of projection when moving past the specified uncomfortable part, whereby a further enhanced massage effect is made available as the member 85 moves along the altered path.

To enable the acupressure member 85 to reliably move past or detour the specified part, it may be useful to temporarily stop the drive mechanism for the member 85 before the member reaches the specified part in inflating or contracting the opposite-side air bags 80, 80 and to resume the movement of the member 86 after the sole is moved to the desired position. When the airbags 80, 80 are inflated or contracted before the acupressure member 85 reaches the specified part, the speed of movement of the member 85 may be reduced.

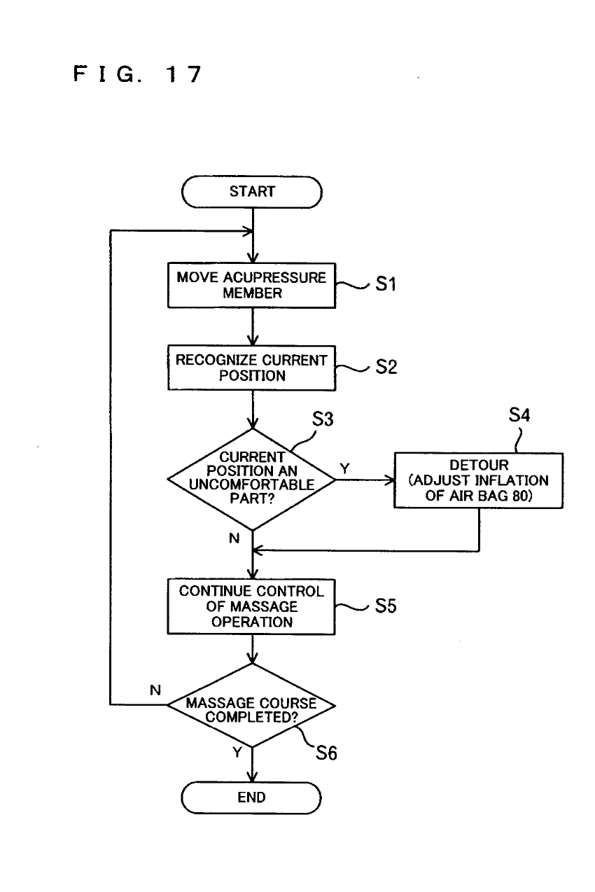

The acupressure member 85 can be given a path of movement for moving past or detouring the specified part according to a predetermined program for the control means 90. As such an example, FIG. 17 shows a flow chart of a procedure for causing the member 85 to detour the specified uncomfortable part.

When the acupressure member 85 moves with the start of a massage operation (step 1), the control means 90 recognizes the current position of the member 85 (step 2). The current position can be recognized by counting up the output pulses of the motor 89 for driving the acupressure member 85 by a motor encoder 92 (see FIG. 12) and checking the count with reference to a predetermined reference point (which can be provided as by a limit switch 92a located closest to the heel side).

When the current position of the acupressure member 85 coincides with the predetermined specified uncomfortable part (step 3) with a movement of the member, the degree of inflation of the air bags 80, 80 is adjusted by the control means 90, for example, as shown in FIG. 16, whereby the part is detoured (step 4).

If the current position is not the specified uncomfortable part (N for step 3) and on completion of the detour (step 4), the control of massage operation is continued.

When a command to stop massage is given by an action of the user or a timer or the like, the massage course is completed (step 5).

The above procedure affords a massage operation wherein the acupressure member 85 makes a detour around the specified uncomfortable part.

The acupressure member 85 is caused to move past the specified part of high massage effect by causing the control means to recognize that the current position is that specified part in FIG. 17, step 3 and adjusting the degree of inflation of the air bags 80, 80 so that the acupressure member 85 moves past the specified part in step 4.

The path of movement for the member 85 to move past or detour the specified part may be set by an action of the user on the manipulator 91.

For this purpose, the manipulator 91 can be provided with an input unit 93 for inputting the specified part. The input unit 93 can be provided by a key for setting the specified part of high massage effect and/or a key for specifying the uncomfortable position. By manual input through the input unit 93, the control means 90 recognizes the specified part to cause the memory means to store the part and to alter the path of movement of the acupressure member 85, whereby massage is given by the member 85 moving past or detouring the specified part.

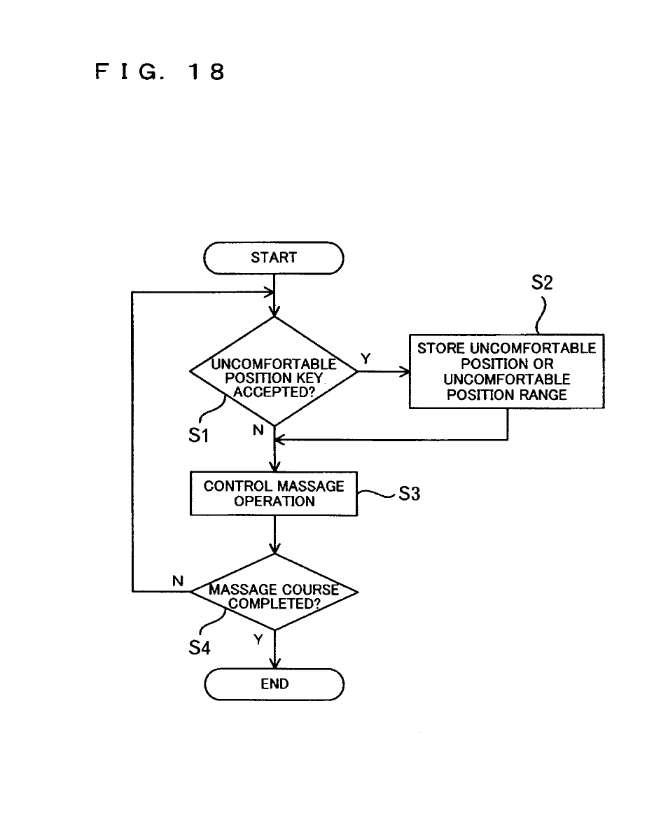

FIG. 18 is a flow chart showing a procedure incorporated into a massage course for setting the specified uncomfortable part. When the user feels discomfort or a pain during the movement of the acupressure member 85, the uncomfortable position key in the input unit 93 is manipulated (step 1), the control means 90 stores the uncomfortable position or an uncomfortable position range in the memory means (step 2), and the path for detouring the specified uncomfortable position is set by the foregoing procedure of FIG. 17 in the subsequent massage operation (step 3).

This eliminates the likelihood that the acupressure member 85 will move past the specified uncomfortable part to provide a comfortable massage in conformity with the difference between individual users.

In the case where the specified part of high massage effect is input through the input unit 93, the path of movement is so set as to cause the acupressure member 85 to move past the specified part concerned.

The leg massage machine 10 described can be used singly as a massage machine useful for legs only, or is usable in chair-type massage machines comprising a seat for the user to sit in, a backrest provided at a rear end of the seat for the back of the user to bear on, and a leg portion provided at a front end of the seat for massaging the calf and foot of the user, for use as the leg portion.

According to the foregoing embodiment, the foot is inserted into the first recessed portion 70 for the acupressure member 85 to massage the sole, whereas the machine is usable also for massaging the rear side of the calf with the acupressure member 85 by inclining the reclining movable assembly 50 rearward as shown in FIG. 2, inserting the foot into the second recessed portion 74 and placing the calf into the first recessed portion 70. In this case, the degree of projection of the acupressure member 85 is variable so as to give suitable intensity when massaging the sole or when massaging the calf.

The leg massage machine described serves to give massage to both the foot and the calf, whereas the machine is of course usable for massaging the foot only or the calf only.

What is claimed is:

1. A leg massage machine comprising:
a recessed portion for the user to insert his or her foot thereinto,
an acupressure member disposed on a bottom wall of the recessed portion for applying pressure to the sole of the user,
a drive mechanism for reciprocatingly moving the acupressure member along the bottom wall of the recessed portion longitudinally thereof,
an air bag disposed on each of opposite side walls of the recessed portion, and
control means for inflating and contracting the air bag on each of the side walls and controlling the drive mechanism,
the leg massage machine being characterized in that the control means controls the inflation of the air bag on each of the side walls and the movement of the acupressure member by the drive mechanism cooperatively.

2. The leg massage machine according to claim 1 wherein the control means so controls as to vary the speed of movement of the acupressure member in accordance with the rate of inflation of the air bags on opposite sides.

3. The leg massage machine according to claim 1 wherein the recessed portion is provided with foot size sensor means for detecting the size of the user's foot as inserted in the recessed portion, and the foot size sensor means is electrically connected to the control means, the control means being adapted to vary the rate of inflation of the air bags on opposite sides and/or the speed of movement of the acupressure member in accordance with the foot size detected by the sensor means.

4. The leg massage machine according to claim 1 wherein the control means so controls as to vary the degree of inflation of the air bags on opposite sides, whereby the sole of the user is moved inside the recessed portion to shift the position of the acupressure member relative to the sole.

5. The leg massage machine according to claim 4 wherein the control means has memory means for storing a specified position of high massage effect in the sole and controls the degree of inflation of the air bags on opposite sides so as to cause the acupressure member to move past the specified position when the acupressure member is moved along the bottom wall of the recessed portion longitudinally thereof by operating the drive mechanism.

6. The leg massage machine according to claim 4 wherein the control means has memory means for storing a specified uncomfortable position in the sole and controls the degree of inflation of the air bags on opposite sides so as not to cause the acupressure member to move past the specified position when the acupressure member is moved along the bottom wall of the recessed portion longitudinally thereof by operating the drive mechanism.

7. The leg massage machine according to claim 5 which has a manipulator electrically connected to the control means and to be manipulated by the user, the manipulator having an input unit for inputting the specified position, the control means being operable to control the degree of inflation of the air bags on opposite sides so as to cause the acupressure member to move past the specified position input by the input unit or so as not to permit the member to move past the specified position.

8. The leg massage machine according to claim 7 wherein the control means causes the memory means to store the specified position input by the input unit.

9. The leg massage machine according to claim 1 wherein the control means varies the speed of movement of the acupressure member by controlling the drive mechanism in accordance with the degree of inflation of the air bags on opposite sides.

10. A chair-type massage machine comprising a seat for the user to sit in, a backrest provided at a rear end of the seat for the back of the user to bear on, and a leg portion provided at a front end of the seat for massaging the calf and foot of the user, the chair-type massage machine being characterized in that the leg portion is the leg massage machine according to claim 1.
